(19) United States
(12) Patent Application Publication
(10) Pub. No.: US 2023/0388698 A1
(43) Pub. Date: Nov. 30, 2023

(54) FOLDABLE HEADPHONE

(71) Applicant: Dongguan Beiou Intelligent Technology Co., Ltd., Dongguan (CN)

(72) Inventor: Yiyong LIU, Dongguan (CN)

(73) Assignee: Dongguan Beiou Intelligent Technology Co., Ltd., Dongguan (CN)

(21) Appl. No.: 18/201,235

(22) Filed: May 24, 2023

(30) Foreign Application Priority Data
May 25, 2022 (CN) 202221285960.3

(51) Int. Cl. H04R 1/10

(52) U.S. Cl. CPC H04R 1/1066; H04R 1/1033; H04R 1/105; H04R 1/1008

(57) ABSTRACT

A foldable headphone includes two earphone bodies, each of which is equipped with a folding bracket. Each folding bracket includes a U-shaped check part, a rotating connection part that extends horizontally outward at both ends of the check part, and a bent and extended headphone connection part at the end far away from the check part. The headphone connection part is connected to the earphone body; Headband: The end of the headband is rotatably connected to the rotating connection part, and two earphone bodies are connected together through the headband. The back of each earphone body is connected to a connecting column, which is connected through a retractable power cord.

### CROSS REFERENCE TO THE RELATED APPLICATIONS

This application is based upon and claims priority to Chinese Patent Application No. 202221285960.3, filed on May 25, 2022, the entire contents of which are incorporated herein by reference.

### TECHNICAL FIELD

The present disclosure relates to the field of headphone technology, in particular to a foldable headphone.

### BACKGROUND

Headphones, as the name suggests, are a type of earphone that is worn on the head rather than inserted into the ear canal. Unlike in-ear earphones, they are composed of two parts: a signal transmitter and earphones with signal reception and amplification devices. With the continuous improvement of living standards, our requirements for headphones are becoming higher and higher. With the development of technology, headphones have greatly developed, and their types and quantities are also increasing day by day, However, there are still issues with this type of headphones that cannot be easily folded and stored.

Currently, foldable headphones on the market have complex folding structures and are not easy to route.

Therefore, there is an urgent need to design a foldable headphone to overcome the shortcomings of existing technology.

### SUMMARY

The technical solution adopted by the present disclosure to achieve the above technical objectives is: a foldable headphone, including: an earphone body, where the earphone body is equipped with two, each of which is equipped with a folding bracket, each of which includes a U-shaped check part and a rotating connection part extending horizontally outward at both ends of the check part, The end of the rotating connection part far from the check part is equipped with a bent and extended headphone connection part, which is connected to the earphone body; A headband, where the end of the headband is rotatably connected to the rotating connection part, and two earphone bodies are connected together through the headband. The back of each earphone body is connected to a connecting column, and the two connecting columns are connected through a telescopic power cord. The middle of the telescopic power cord is fixedly connected to the headband.

In a preferred embodiment, each end of the headband is fixedly connected with two hollow rotating parts spaced apart, and the two rotating connection parts of each folding bracket are respectively located within the corresponding rotating parts.

In a preferred embodiment, the two ends of the headband are respectively equipped with check grooves that are matched with the check parts.

In a preferred embodiment, the check groove is located on the side of the headband away from the head.

In a preferred embodiment, both sides of each earphone body are rotationally connected with foldable columns, and the earphone connection part is inserted into the foldable column and connected with the foldable column.

In a preferred embodiment, the earphone connection portion is provided with an outward protruding protrusion at one end far from the rotating connection portion, which is in contact with the inner wall of the foldable column.

The advantage of the present disclosure is that the setting of the folding bracket enables the two earphone bodies to be folded and stored. The folding bracket has a simple structure and low production cost. At the same time, the setting of the connecting column enables the electrical connection of the two earphone bodies, with simple wiring, and the folding is not limited by the length of the power cord, without the need to reserve a power cord.

### BRIEF DESCRIPTION OF THE DRAWINGS

FIG. 1 is a structural schematic diagram of the present disclosure;

FIG. 2 is an exploded view of the present disclosure;

FIG. 3 is a structural schematic diagram of the folding bracket of the present disclosure.

In the picture:

10. Earphone body; 101. Foldable column; 102. Connecting column; 103. Telescopic power cord: 11. Folding bracket; Ill. Check part; 112. Rotating connection part; 113. Headphone connection part; 114. Convex block; 12. Headband; 121. Check groove; 122. Rotating parts.

### DETAILED DESCRIPTION OF THE EMBODIMENTS

In order to make the above purposes, features, and advantages of the present disclosure more obvious and understandable, the specific implementation methods of the present disclosure will be explained in detail below in conjunction with the accompanying drawings. Many specific details are elaborated in the following description to facilitate a full understanding of the present disclosure. However, the present disclosure can be implemented in many different ways from the other described herein, and those skilled in the art can make similar improvements without violating the connotation of the present disclosure. Therefore, the present disclosure is not limited by the specific embodiments disclosed below.

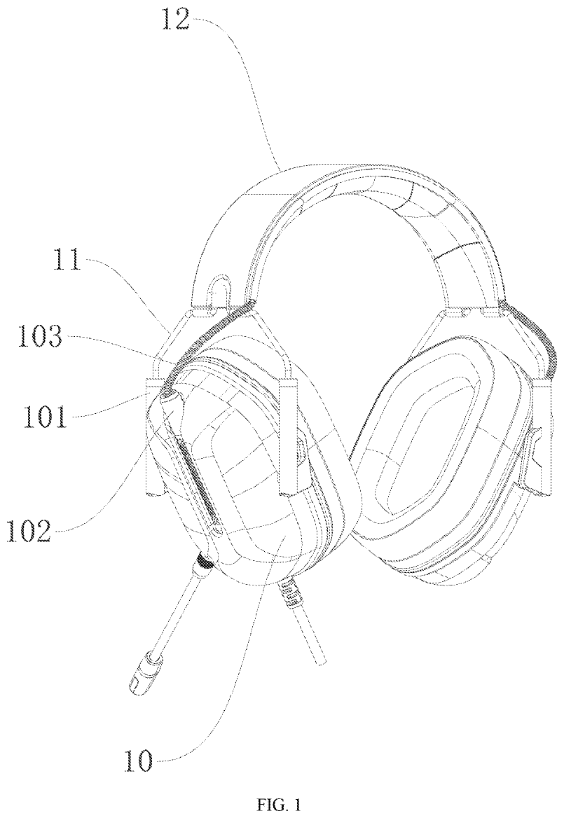

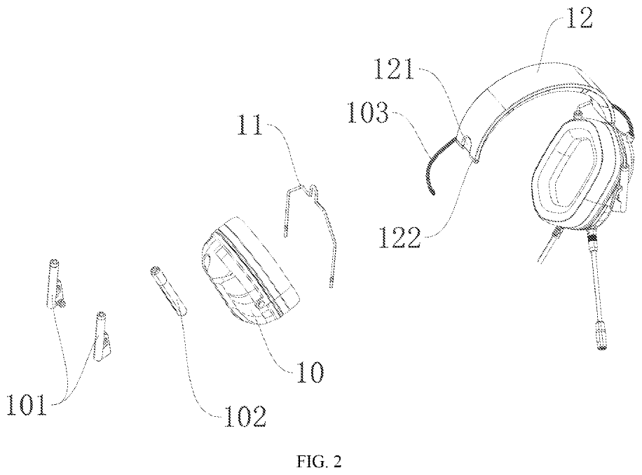

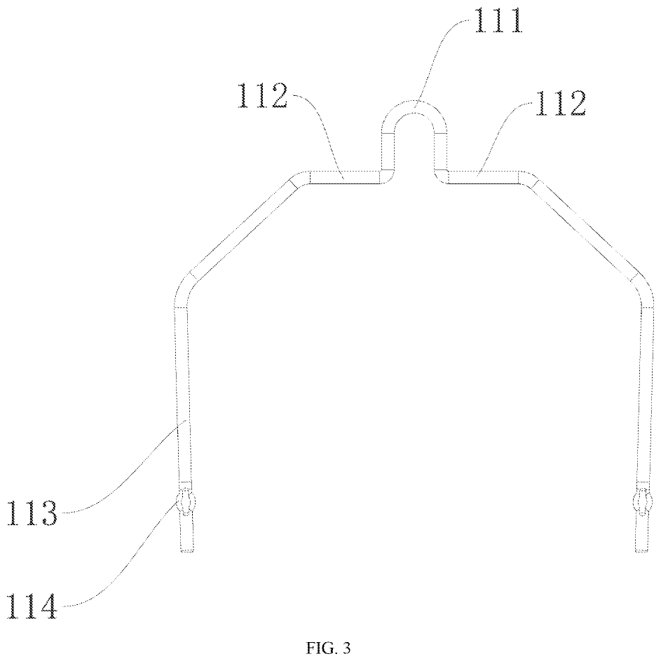

As shown in FIGS. 1 to 3, the present disclosure provides a foldable headphone, including: an earphone body 10, where the earphone body 10 is equipped with two, each of which is equipped with a folding bracket 11. Each folding bracket 11 includes a U-shaped check part 111, and a rotating connection part 112 extending horizontally outward at both ends of the check part 111. The end of the rotating connection part 112 far from the check part 111 is equipped with a bent and extended earphone connection part 113, which is connected to the earphone body 10; Headband 12, where the end of the headband 12 is rotatably connected to the rotational connection part 112, two earphone bodies 10 are connected together through the headband 12, and a connecting column 102 is inserted at the back of each earphone body 10. The two connecting columns 102 are connected through a telescopic power cord 103, and the middle of the telescopic power cord 103 is fixedly connected to the headband 12. Specifically, the headband 12 is connected to the earphone body 10 through a folding bracket 11, Two earphone bodies 10 are arranged at both ends of the headband 12, and are connected to the headband 12 through the rotation of the folding bracket 11, which allows the folding bracket 11 to rotate relative to the end of the headband 12. At the same time, the rotation direction is limited by the check part 111, so that the folding bracket 11 can only rotate towards the inner surface of the headband 12. When folding, the first end of the earphone body 10 is completely folded into the inner surface of the headband 12, The second end of the earphone body 10 is stacked on the first end of the earphone body 10 to achieve the folding of the earphones, and the two earphone bodies 10 are electrically connected through the connecting column 102. The two connecting columns 102 are connected through the telescopic power cord 103, so that the earphone body 10 can be folded without being limited by the power cord, and there will be no excess protruding parts of the power cord when in use.

Furthermore, in this embodiment, each end of the headband 12 is fixedly connected with two hollow rotating parts 122 spaced apart, and the two rotating connection parts 112 of each folding bracket 11 are respectively located within the corresponding rotating parts 122. Specifically, each end of the two ends of the headband 12 is fixedly connected with two hollow rotating parts 122 spaced apart, and the rotating parts 122 are fixedly connected to the headband 12, The rotating connection part 112 of the folding bracket 11 is located within the rotating parts 122 and can rotate within the rotating parts 122, and the translation of the folding bracket 11 is limited by the bent and extended headphone connection part 113.

Furthermore, in this embodiment, the two ends of the headband 12 are respectively equipped with check grooves 121 that are matched with the check part 111. Specifically, the check groove 121 can be set as a U-shaped groove that is suitable for the check part 111. When the folding bracket 11 rotates outward to a certain angle, the check part 111 engages in the check groove 121, restricting the folding bracket 11 from continuing to rotate, so that the earphone body 10 has a comfortable wearing angle.

Furthermore, in this embodiment, the check groove 121 is located on the side of the headband 12 that is away from the head. Specifically, the check groove 121 is located on the side of the headband 12 that is away from the head, so that the folding bracket 11 can only rotate inward at a large angle, while when rotated outward at a certain angle, it is restricted by the check groove 121 and cannot continue to rotate.

Furthermore, in this embodiment, the two sides of each earphone body 10 are rotationally connected with a foldable column 101, and the headphone connection part 113 is inserted into the foldable column 101 to connect with the foldable column 101. Specifically, the foldable column 101 is rotationally connected on both sides of each earphone body 10, and the foldable column 101 can rotate relative to the earphone body 10 to avoid the folding of the earphone body 10 at the first end, The second end earphone body 10 is limited by the first end earphone body 10 and cannot be folded. By setting the foldable column 101, the earphone body 10 can rotate relative to the foldable column 101, so that the second end earphone body 10 can be stacked outside the first end earphone body 10.

Furthermore, at one end of the earphone connection part 113 that is far away from the rotating connection part 112, there is a convex block 114 protruding outward, which is in contact with the inner wall of the foldable column 101. Specifically, to prevent the earphone connection part 113 from detaching from the foldable column 101 under the gravitational influence of the earphone body 10 during use, there are two convex blocks 114 protruding in opposite directions at the end of the earphone connection part 113 that is far away from the rotating connection part 112, When inserting the headphone connection part 113 into the foldable column 101, the frictional force generated by the compression between the convex block 114 and the inner wall of the foldable column 101 limits the movement of the headphone connection part 113.

In summary, the present disclosure allows two earphone bodies 10 to be folded and stored through the setting of the folding bracket 11. The folding bracket 11 has a simple structure and low production cost. At the same time, through the setting of the connecting column 102, the two earphone bodies 10 are electrically connected, with simple wiring, and the folding is not limited by the length of the power cord, and there is no need to reserve a power cord.

The present disclosure is not limited to the description in the specification and implementation methods, so it can easily achieve additional advantages and modifications for those familiar with the field. Therefore, without departing from the spirit and scope of the general concepts defined by the claims and equivalent scope, the present disclosure is not limited to specific details, representative devices, and the illustrated examples shown and described here.

What is claimed is:

1. A foldable headphone comprising an earphone body, wherein the earphone body is equipped with two, each of the two earphone bodies is equipped with a folding bracket;
each folding bracket comprises a U-shaped check part, a rotating connection part extending horizontally outward at two ends of the U-shaped check part, and a bent and extended headphone connection part at an end far from the U-shaped check part, the bent and extended headphone connection part is connected to the earphone body; a headband, wherein an end of the headband is rotatably connected to the rotating connection part, and two earphone bodies are connected together through the headband;
a back of each earphone body is connected to a connecting column, and the two connecting columns are connected through a telescopic power cord; and
a middle of the telescopic power cord is fixedly connected to the headband.

2. The foldable headphone according to claim 1, wherein each end of the headband is fixedly connected with two hollow rotating parts with spacing settings, and the two rotating connection parts of each foldable bracket are respectively located within the corresponding rotating parts.

3. The foldable headphone according to claim 1, wherein two ends of the headband are respectively equipped with a check groove, wherein the check groove matches the U-shaped check part.

4. The foldable headphone according to claim 3, wherein the check groove is arranged on a side of the headband away from a head.

5. The foldable headphone according to claim 1, wherein each side of the earphone body is rotatably connected to a foldable column, and the bent and extended headphone connection part is inserted into the foldable column and connected to the foldable column.

6. The foldable headphone according to claim 5, wherein one end of the bent and extended headphone connection part far from the rotating connection part is provided with a protruding block, wherein the protruding block is in contact with an inner wall of the foldable column.
